(19) United States
(12) Patent Application Publication
(10) Pub. No.: US 2010/0322446 A1
(43) Pub. Date: Dec. 23, 2010

(54) Spatial Audio Object Coding (SAOC) Decoder and Postprocessor for Hearing Aids

(75) Inventor: Stefan Strahl, Innsbruck (AT)

Correspondence Address: Sunstein Kann Murphy & Timbers LLP, 125 SUMMER STREET, BOSTON, MA, 02110-1618, US

(73) Assignee: MED-EL ELEKTROMEDIZINISCHE GERAETE GMBH, Innsbruck (AT)

(21) Appl. No.: 12/817,363

(22) Filed: Jun. 17, 2010

Related U.S. Application Data
(60) Provisional application No. 61/187,742, filed on Jun. 17, 2009.

(51) Int. Cl. H04R 25/00

(52) U.S. Cl. 381/312

(57) ABSTRACT

An audio processor device for a hearing impaired listener is described. An input signal decoder decodes an audio input data signal into a corresponding multi-channel audio output representing multiple audio objects and associated side information. An audio processor adjusts the multi-channel audio output based on user-specific hearing impairment characteristics to produce a post-processed audio output to improve auditory scene analysis (ASA) by the hearing impaired listener of the audio objects.

This application claims priority from U.S. Provisional Patent Application 61/187,742, filed Jun. 17, 2009; incorporated herein by reference.

### FIELD OF THE INVENTION

The present invention relates to medical devices, and more specifically to audio signal processing in hearing prosthetic devices.

### BACKGROUND ART

The human auditory processing system segregates sound objects from complex auditory scenes using several binaural cues such as interaural time and level differences (ITD/ILD) and monaural cues such as harmonicity or common onset. This process is known as auditory scene analysis (ASA) as described more fully in A. S. Bregman Auditory Scene Analysis: The Perceptual Organization of Sound, MIT Press, Cambridge, Mass. (1990), incorporated herein by reference.

Hearing impaired patients have difficulties successfully performing such an auditory scene analysis even with a hearing prosthesis such as a conventional hearing aid, a middle-ear prosthesis, a bone-anchored hearing prosthesis, a cochlear implant (CI), or an auditory brainstem implant (ABI). This is especially a problem for audio recordings and live audio streaming Processing methods such as directional microphones or steerable beamforming do not help hearing prostheses handle audio recordings played with standard sound systems, (i.e. stereo loudspeakers or headphones) because such techniques require true spatial sound sources. In addition, cues such as harmonicity, which the normal human auditory processing system uses for ASA, are not correctly reproduced by the hearing prostheses (especially, for example, cochlear implants and auditory brainstem implants).

Because of such problems, hearing aid users often are unable to listen to a single individual sound source within a mixture of multiple sound sources. In the case of understanding speech, this translates into reduced speech intelligibility. In the case of music, musical perception is degraded due to the inability to successfully isolate and follow individual instruments.

To assist hearing aid users in performing an auditory scene analysis, an alteration of the sound mixture is normally applied that emphasizes the sound sources of interest. Some techniques such as beamforming only work with real spatial sound sources, so the only available solution for normal down-mixed sound recordings is to perform a computational ASA separating the sound sources automatically. Presently, no such source separation algorithm is known that is able to perform the necessary object discrimination in a computationally reasonable and robust way.

The upcoming MPEG standard for multi-channel audio recording “Spatial Audio Object Coding” (SAOC) transmits side information allowing access at recording time to all separately recorded sound sources; see Breebaart et al., Spatial Audio Object Coding (SAOC)-The Upcoming MPEG Standard on Parametric Object Based Audio Coding, Proceedings of the 124th Convention of the Audio Engineering Society, Paper#7377 (2008); incorporated herein by reference. To date, no SAOC decoder and mixer concept has been published that uses characteristics of the listener's hearing impairment (e.g. audiogram), an audio processor setting (e.g. coding strategy, fitting map, . . . ) and the available SAOC side information to optimize the playback of audio recordings or live-streamings by post-processing and remixing the sound sources for the individual hearing impaired listener. In addition, to date, there has been no description presented of any direct input of the MPEG-SAOC bitstream to an audio processor to directly utilize the available audio object meta data.

### SUMMARY OF THE INVENTION

Embodiments of the present invention are directed to an audio processor device and corresponding method for a hearing impaired listener. An input signal decoder decodes an audio input data signal into a corresponding multi-channel audio output representing multiple audio objects and associated side information. An audio processor adjusts the multi-channel audio output based on user-specific hearing impairment characteristics to produce a post-processed audio output to improve auditory scene analysis (ASA) by the hearing impaired listener of the audio objects.

The audio input data signal may more specifically include Spatial Audio Object Coding (SAOC) data, in which case, the associated side information may be Object Level Difference (OLD) and/or Inter-Object Cross-Coherence (IOC) information. The audio input data signal may be based on an audio recording playback signal or a real time audio source. The user-specific hearing impairment characteristics may include user audiogram data and/or user-specific processing fit data. Adjusting the multi-channel audio output may further be based on a coding strategy associated with the post-processed audio output. The device may more specifically be part of a conventional hearing aid system, a middle ear prosthesis system or a cochlear implant system.

### BRIEF DESCRIPTION OF THE DRAWINGS

FIG. 1 shows an example of an audio processor device according to one specific embodiment of the present invention.

FIG. 2 shows an example of another specific embodiment.

FIG. 3A-B shows how shifting the pitch of sound objects avoids undesired merger of the objects onto a single stimulation electrode.

### DETAILED DESCRIPTION OF SPECIFIC EMBODIMENTS

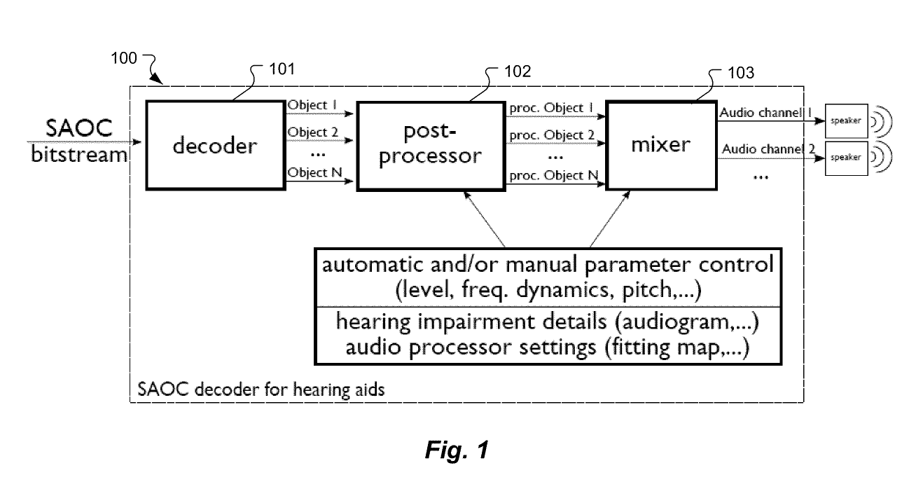

Embodiments of the present invention are directed to an audio processor device and corresponding method for a hearing impaired listener. FIG. 1 shows an example of an audio processor device 100 having an input signal decoder 101 that decodes an audio input data signal into a corresponding multi-channel audio output representing multiple audio objects and associated side information. An audio processor 102 then adjusts the multi-channel audio output based on user-specific hearing impairment characteristics. A mixer 103 combines the post-processed audio output into audio output channels such as a standard stereo audio signal or a direct audio input of a hearing aid. Either or both of the audio processor 102 and the mixer 103 take into account (manually or automatically) the details of the users specific hearing impairment (e.g. audiogram, . . . ) and an audio processor setting (e.g. coding strategy, fitting map, . . . ) to produce a post-processed audio output that improves auditory scene analysis (ASA) by the hearing impaired listener of the audio objects encoded in the audio input data signal.

More specifically, audio input data signal to the input signal decoder 101 may more specifically include Spatial Audio Object Coding (SAOC) data, in which case, the input signal decoder 101 decodes the number of audio objects (N), the down-mix audio signals, and the side information for all N objects (e.g., Object Level Difference (OLD) and/or Inter-Object Cross-Coherence (IOC) information). For example, an SAOC bitstream may be based on an audio recording playback signal from a storage device (CD/DVD, hard disk, flash memory within a portable device, . . . ) or a real time audio source such as from a live streaming connection (internet, TV channel, . . . ). And the audio processor device 100 may be available at the user's personal computer, within a mobile device, or at any other device that would normally perform the standard SAOC decoding taking into account the user-specific hearing impairment characteristics. The audio processor device 100 also may more specifically be part of a conventional hearing aid system, a middle ear prosthesis system or a cochlear implant system.

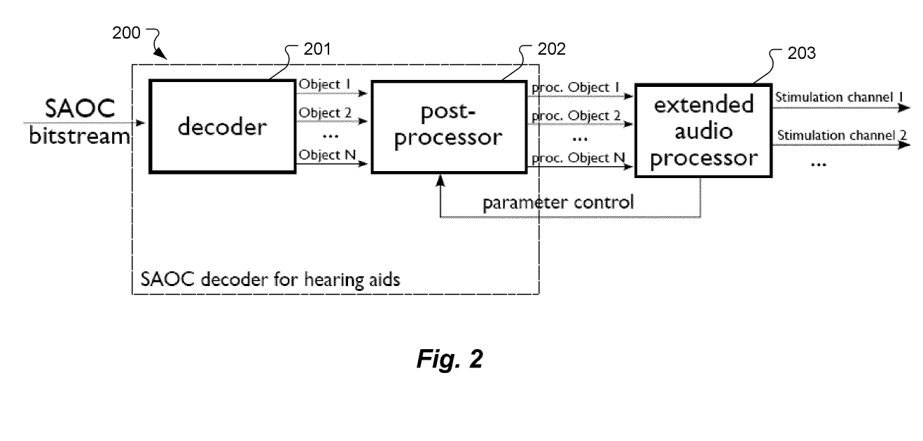

FIG. 2 shows an example of another arrangement of an audio processor device 200 having an input signal decoder 201, an audio processor 202 and an extended audio processor 203 of a hearing aid. In contrast to the arrangement described with regards to FIG. 1, in this system, the processed audio objects in the post-processed audio output are made directly available to the audio processor of the hearing aid, the extended audio processor 203, for example, by using a cable or a wireless communication link. This additional information related to the number of the sound sources present in the audio input data signal and their waveforms (not before available) allows the extended audio processor 203 to optimize its signal processing to improve the auditory scene analysis (ASA) by the hearing impaired listener as compared to a standard audio processor. This additional audio object information also allows new signal processing algorithms to be used based on the separated sound objects. That is, based on the known user-specific hearing impairment characteristics and the chosen signal processing parameters, the audio processor device 200 can control the input signal decoder 201, audio processor 202 and extended audio processor 203 to further improve the listening performance of the hearing impaired user.

An illustrative scenario in which such arrangements would be useful is a case of a movie scene with two voice tracks of a male actor and a female actor talking in front of a third sound object such as an operating television set. The information of the user-specific hearing impairment characteristics and the audio processor settings of the hearing aid may be used to determine that the female voice has a fundamental frequency that highly overlaps with the speech-like noise from the television, and that this will lead to reduced speech intelligibility for the hearing impaired listener. For each individual audio object, the audio processor device can change the corresponding audio properties such as level, frequency dynamics, and/or pitch, so that an appropriate increase in level of the female speaker and a corresponding decrease in level of the TV could be applied to increase the speech intelligibility of the female speaker.

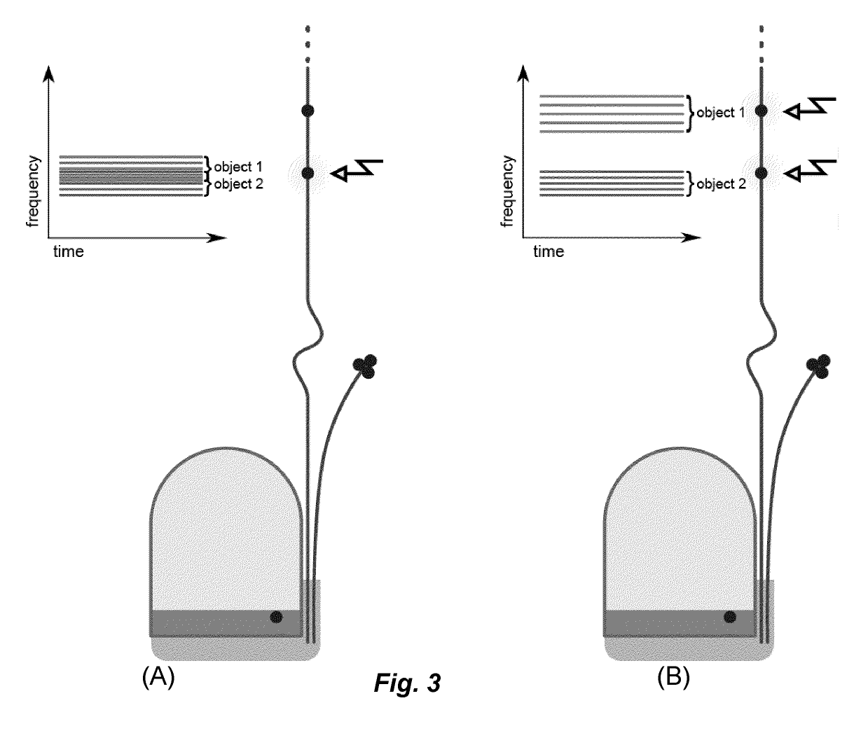

Another similar example would be pitch shifts of the sound objects so that for a user of a cochlear implant or auditory brainstem implant the two objects are mapped to two different electrodes. FIG. 3A shows an example of two sound objects—object 1 and object 2—that are merged into a single sound object as mapped to one stimulation electrode. By shifting the pitch of object 1, a merger into a single object can be avoid as shown in FIG. 3B, where the pitch of object 1 is increased to map it to a separate electrode from object 2.

Another setting in which embodiments of the invention could be useful would be from a recording of a music concert having multiple different sound groups (e.g., N˜19). A user of the audio processor device could listen to the same musical scenes multiple times, once with emphasis on the strings, a second time with emphasis on the woodwinds, etc. This is enabled because the mixer in the audio processor device adds all N separate sound sources into the M output channels of the listener's sound system (M=2 for a stereo sound system). For every sound source, individual level parameters can be applied depending on the hearing impaired listener's predicted intelligibility or personal settings. This would allow a user to repeatedly listen to complex auditory scenes with changing audio emphasis on different auditory objects. For example, two instruments with a relatively small spectral bandwidth and different fundamental frequencies might fall in the same analysis filters of the audio processor device and could thereby be perceived (e.g., based on an artificially introduced harmonicity cue) as a single object with mismatching time-onsets. But this disturbance could be resolved by lowering the level of one instrument or pitch shifting one sound object (as shown in FIG. 3A-B) so that it will be placed in the next analysis filter, thereby allowing the hearing impaired user to perceive the musical structure again.

Another illustrative scenario could be a broadcast of a discussion with many competing speakers. The extended audio processor can act as an active component that uses the available Object Level Differences (OLD) and Inter-Object Cross Coherence (IOC) information to control the decoder to optimize its resulting amplification or in the stimulus patterns of a cochlear implant or auditory brainstem implant. Depending on a priority list that may be either automatically computed or user controlled, the intelligibility can be computed for every audio object in the mixed presentation, and audio objects having a relatively low priority that degrade the intelligibility of other audio objects with a higher priority, can be lowered adjusted to allow a better ASA performance, for example, by an adjustment in sound level, post-processing adjustment, or removal from the audio mixture.

Embodiments of the invention may be implemented in whole or in part in any conventional computer programming language. For example, preferred embodiments may be implemented in a procedural programming language (e.g., “C”) or an object oriented programming language (e.g., “C++”, Python). Alternative embodiments of the invention may be implemented as pre-programmed hardware elements, other related components, or as a combination of hardware and software components.

Embodiments can be implemented in whole or in part as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. An audio processor device for a hearing impaired listener, the device comprising:
an input signal decoder for decoding an audio input data signal into a corresponding multi-channel audio output representing a plurality of audio objects and associated side information; and
an audio processor for adjusting the multi-channel audio output based on user-specific hearing impairment characteristics to produce a post-processed audio output for auditory scene analysis (ASA) by the hearing impaired listener of the audio objects.

2. A device according to claim 1, wherein the audio input data signal includes Spatial Audio Object Coding (SAOC) data.

3. A device according to claim 2, wherein the associated side information includes at least one of Object Level Difference (OLD) and Inter-Object Cross-Coherence (IOC) information.

4. A device according to claim 1, wherein the audio input data signal is based on an audio recording playback signal.

5. A device according to claim 1, wherein the audio input data signal is based on a real time audio source.

6. A device according to claim 1, wherein the user-specific hearing impairment characteristics include user audiogram data.

7. A device according to claim 1, wherein the user-specific hearing impairment characteristics include user-specific processing fit data.

8. A device according to claim 1, wherein adjusting the multi-channel audio output is further based on a coding strategy associated with the post-processed audio output.

9. A conventional hearing aid system having a device according to any of claims 1-9.

10. A middle ear prosthesis system having a device according to any of claims 1-9.

11. A cochlear implant system having a device according to any of claims 1-9.

12. A method of processing audio signals for a hearing impaired listener, the method comprising:
automatically decoding an audio input data signal into a corresponding multi-channel audio output representing a plurality of audio objects and associated side information; and
adjusting the multi-channel audio output based on user-specific hearing impairment characteristics to produce a post-processed audio output for auditory scene analysis (ASA) by the hearing impaired listener of the audio objects.

13. A method according to claim 12, wherein the audio input data signal includes Spatial Audio Object Coding (SAOC) data.

14. A method according to claim 2, wherein the associated side information includes at least one of Object Level Difference (OLD) and Inter-Object Cross-Coherence (IOC) information.

15. A method according to claim 12, wherein the audio input data signal is based on an audio recording playback signal.

16. A method according to claim 12, wherein the audio input data signal is based on a real time audio source.

17. A method according to claim 12, wherein the user-specific hearing impairment characteristics include user audiogram data.

18. A method according to claim 12, wherein the user-specific hearing impairment characteristics include user-specific processing fit data.

19. A method according to claim 12, wherein adjusting the multi-channel audio output is further based on a coding strategy associated with the post-processed audio output.

20. A conventional hearing aid system using the method according to any of claims 12-19.

21. A middle ear prosthesis system using the method according to any of claims 12-19.

22. A cochlear implant system using the method according to any of claims 12-19.
